(19) United States
(12) Patent Application Publication
(10) Pub. No.: US 2024/0407060 A1
(43) Pub. Date: Dec. 5, 2024

(54) GRAPHITE STRUCTURE HAVING HIGH MAGNETIC FLUX DENSITY DURING INDUCTION HEATING, AND ARRANGEMENT METHOD THEREFOR

(71) Applicants: LG ELECTRONICS INC., Seoul (KR); Mokpo National University Industry-Academic Cooperation Foundation, Muan-gun, Jeollanam-do (KR)

(72) Inventors: Jaeyoung SHIN, Seoul (KR); Taeho KIM, Seoul (KR); Yongsoo LEE, Seoul (KR); Taehee KIM, Seoul (KR); Juhyeong KIM, Seoul (KR); Seokkyun SON, Mokpo-si (KR); Dohun KIM, Yongin-si (KR)

(73) Assignees: LG ELECTRONICS INC., Seoul (KR); Mokpo National University Industry-Academic Cooperation Foundation, Muan-gun, Jeollanam-do (KR)

(21) Appl. No.: 18/270,365

(22) PCT Filed: Feb. 1, 2021
(86) PCT No.: PCT/KR2021/001307

§ 371 Date: Aug. 12, 2024

(30) Foreign Application Priority Data
Dec. 30, 2020 (KR) 10-2020-0187889

(51) Int. Cl. H05B 6/12; H01B 1/04; H01B 5/00

(52) U.S. Cl. CPC H05B 6/1209; H01B 1/04; H01B 5/00; H05B 2213/05

(57) ABSTRACT

A graphite structure includes multiple graphite blocks and one or more connection links connecting multiple graphite blocks to each other.

### CROSS-REFERENCE TO RELATED APPLICATIONS

This application is the National Phase of PCT International Application No. PCT/KR2021/001307, filed on Feb. 1, 2021, which claims priority to and the benefit of Patent Application No. 10-2020-0187889 filed in the Republic of Korea on Dec. 30, 2020, all of which are hereby expressly incorporated by reference into the present application.

### TECHNICAL FIELD

The present disclosure relates to a graphite structure having high magnetic flux density upon induction heating and an arrangement method thereof.

### BACKGROUND ART

Graphite is one of the carbon allotropes and has high electrical conductivity due to the plate-like arrangement of atoms. In general, graphite is light in weight and has a high electrical conductivity that is greater than the electrical conductivity of stainless steel, which is used as an object to be heated during induction heating, and thus has high energy efficiency.

However, the graphite has a brittle property (graphite can be brittle), making it difficult to apply large-area graphite, and small-area graphite does not have a high magnetic flux density, making it difficult to select an object to be heated for induction heating. That is, it can be difficult to determine or sense that graphite is present on the induction heating cooker.

In particular, since most of induction heating cookers are designed to stop the induction heating when it is determined that there is no object to be heated, it is difficult for graphite to become an object to be heated.

### SUMMARY OF THE DISCLOSURE

An object of the present disclosure is to provide a graphite structure having a high magnetic flux density during induction heating.

An object of the present disclosure is to provide an arrangement of a graphite structure having a high magnetic flux density during induction heating.

A graphite structure according to the present disclosure can include a plurality of graphite blocks and one or more connection links connecting the plurality of graphite blocks to each other.

The at least one connection link can be a conductor.

An arrangement method of a graphite structure includes disposing a plurality of graphite blocks on a predetermined surface, and disposing at least one or more connection links connecting the plurality of graphite blocks to each other.

### ADVANTAGEOUS EFFECTS

According to the present disclosure, there can be the advantage in that the graphite block is capable of being used as the main object to be heated or the auxiliary object to be heated for the induction heating.

According to the present disclosure, the magnetic flux similar to that of the large graphite block can be induced with the small graphite blocks, which is advantageous to the process, in that small graphite blocks normally are difficult to heat by induction heating, due to having a low (e.g., lower) magnetic flux density.

According to the present disclosure, there can be the advantage in that the object to be heated can have flexibility (e.g., can be elastic) and is manufactured by arranging the small graphite blocks on a curved surface.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIGS. 1 and 2 are views for explaining heating characteristics depending on an area of a graphite block according to an embodiment of the present disclosure.

FIG. 3 is a view illustrating a magnetic flux density of graphite according to an embodiment of the present disclosure.

(a) of FIG. 4 illustrates the working coil and a diameter of the working coil according to an embodiment of the present disclosure, (b) of FIG. 4 is a graph illustrating a magnetic flux density of a graphite according to an embodiment of the present disclosure, and (c) of FIG. 4 is a graph illustrating the total magnetic flux density of the graphite according to an embodiment of the present disclosure.

FIG. 5 is a view of a graphite block according to an embodiment of the present disclosure.

FIG. 6 is a view of a graphite structure according to an embodiment of the present disclosure.

FIG. 7 is a view of a graphite structure according to an embodiment of the present disclosure.

(a) of FIG. 8 is a view of a graphite structure according to an embodiment of the present disclosure, and (b) of FIG. 8 is a graph illustrating a comparison between a distance between the graphite blocks and a time to reach 100° C.

### DETAILED DESCRIPTION OF THE EMBODIMENTS

Hereinafter, embodiments according to the present disclosure will be described in detail with reference to the accompanying drawings. In the drawings, the same reference numerals are used to denote the same or similar elements.

Hereinafter, a graphite structure according to an embodiment of the present disclosure will be described.

Graphite is one of the carbon allotropes and has high electrical conductivity due to the plate-like arrangement of atoms. In general, graphite is light in weight and has high electrical conductivity greater than that of stainless steel, which is used as an object to be heated during induction heating, and thus has high energy efficiency.

However, the graphite has a brittle property, making it difficult to apply large-area graphite, and small-area graphite does not have a high magnetic flux density, making it difficult to select an object to be heated for induction heating.

In particular, since most of induction heating cookers are designed to stop the induction heating when it is determined that there is no object to be heated, it is difficult for graphite to become an object to be heated.

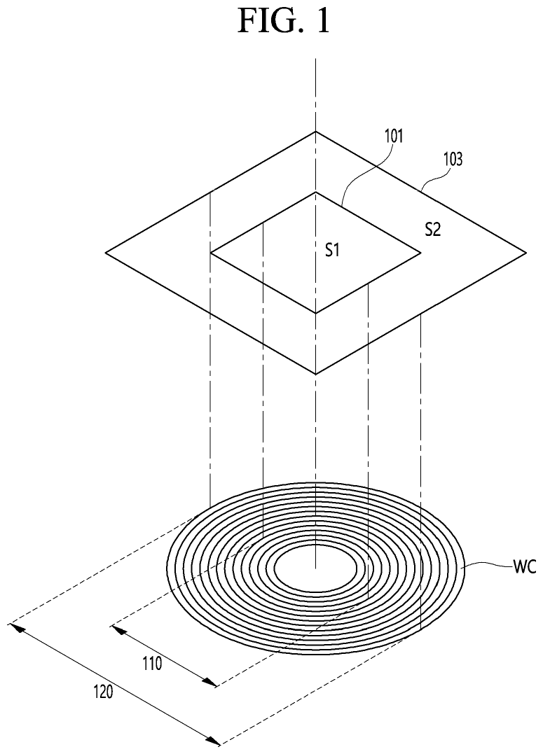

Next, a principle of heating graphite according to an embodiment of the present disclosure when the graphite has a cross-sectional area equal to or greater than a certain amount will be described with reference to FIGS. 1 to 4.

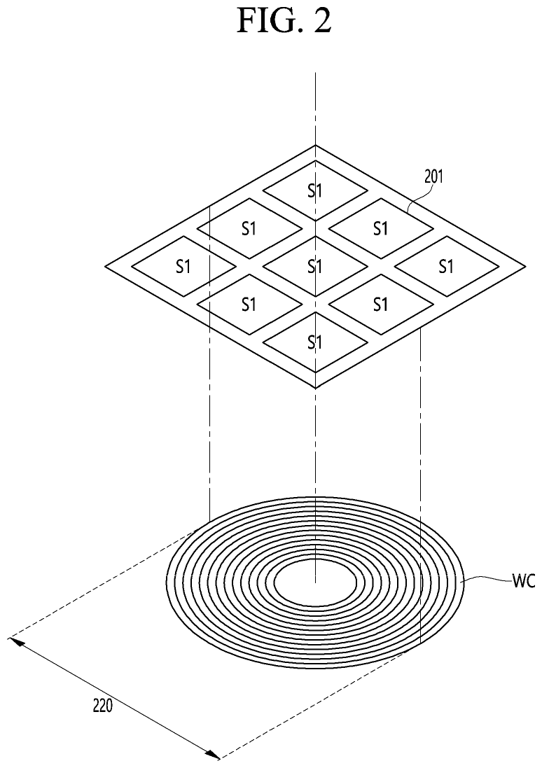

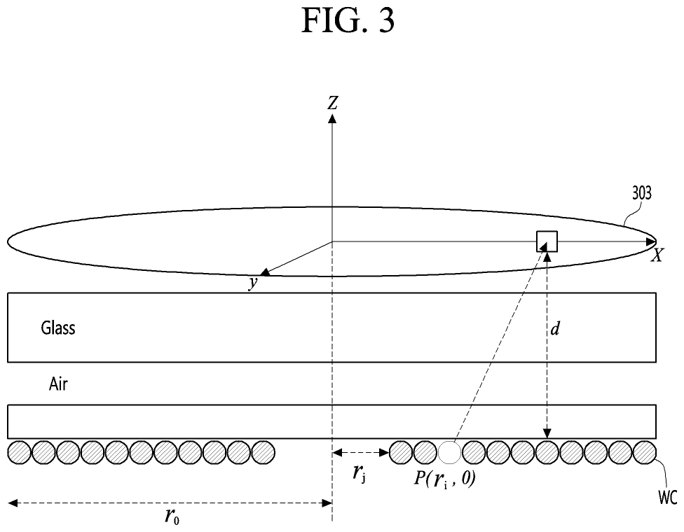

FIGS. 1 and 2 are views illustrating heating characteristics depending on an area of a graphite block according to an embodiment of the present disclosure.

First, referring to FIG. 1, an induction heating cooker (e.g., induction heater) can be designed to stop an operation of a working coil WC when it is determined that there is no container on the working coil WC.

As illustrated in FIG. 1, whether to stop a heating operation of the induction heating cooker can be determined according to a cross-sectional area of a graphite 101 or 103 (e.g., an element comprised of or including graphite) placed on a working coil WC of the induction heating cooker. For example, when the graphite 101 having a first cross-sectional area S1 in which one side has a first length 110 is placed on the working coil WC, the induction heating cooker can determine that the object to be heated does not exist, to stop the heating. That is, the induction heating cooker cannot determine if the graphite object 101 having the first cross-sectional area SI exists, because the graphite object 101 has too low of a magnetic flux density. In addition, when the graphite 103 having a second cross-sectional area S2 in which one side has a second length 120 greater than the first length 110 is placed on the working coil WC, the induction heating cooker can determine that the object to be heated exists, so as not to stop the heating.

Here, if the area of the graphite is greater than the first cross-sectional area S1 and less than the second cross-sectional area S2, the induction heating cooker can determine that the object to be heated exists. That is, the induction heating cooker can determine that a container exists only when the graphite having a predetermined cross-sectional area or more is placed on the working coil WC and thus may not stop the heating. In addition, the predetermined cross-sectional area of the graphite described above can be proportional to a diameter of the working coil WC. That is, when the diameter of the working coil WC increases, the cross-sectional area of the graphite required to determine that the object to be heated exists can also increase.

Next, referring to FIG. 2, when a plurality of graphites 201 (e.g., elements comprised of or including graphite), each of which has the first cross-sectional area S1, are placed on (e.g., or overlapping) the working coil WC of the induction heating cooker having a diameter of a second length 220 that is equal to a second length 120 of FIG. 1, the induction heating cooker can stop the heating by determining that the object to be heated does not exist. That is, as illustrated in FIG. 2, although the sum of the cross-sectional areas of pieces of the graphite 201 exceeds the first cross-sectional area S1, the induction heating cooker can determine that there is no object to be heated and thus stop the heating.

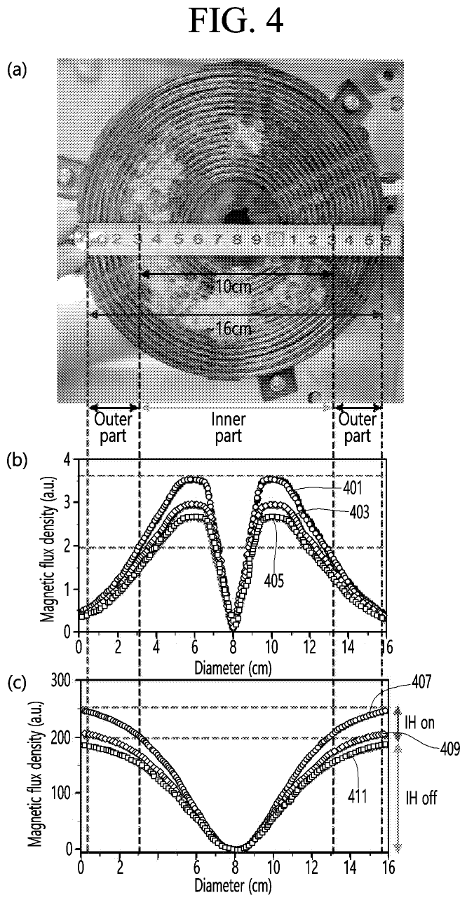

Next, FIGS. 3 and 4 are views illustrating a magnetic flux density of the graphite according to an embodiment of the present disclosure.

FIG. 3 illustrates a side view of the working coil and the graphite (e.g., element comprised of or including graphite) according to an embodiment of the present disclosure. The glass of the cooker represents the upper plate glass, onto which a material (e.g., graphite material) is placed. Here, an element 303 comprising or including graphite is shown.

(a) of FIG. 4 is a view illustrating the working coil and a diameter of the working coil according to an embodiment of the present disclosure, (b) of FIG. 4 is a graph illustrating a magnetic flux density of a graphite depending on a distance from a central portion of the working coil according to an embodiment of the present disclosure, and (c) of FIG. 4 is a graph illustrating the total magnetic flux density of the graphite according to the distance from the central portion of the working coil according to an embodiment of the present disclosure.

First, a method for obtaining the total magnetic flux density of a graphite 303 spaced a vertical distance d from the working coil WC will be described through Equations with reference to FIG. 3.

Below, in [Equation 1] to [Equation 4], μ₀ can mean permittivity of vacuum (e.g., vacuum permittivity), and μᵣ , can mean permittivity of graphite.

B means a magnetic flux density, A means an operating frequency, jωσA means an induced eddy current, J means a current density of a coil (e.g., the working coil), I means primary current (e.g., primary current through the coil), and k means an integral constant, and J(kr) can mean a Bessel function of the first kind.

$$∇ \times B = {μ}_{0} {μ}_{r} ( j ω σ A - J ) \qquad [ Equation 1 ]$$

$$A ( r , z ) = {μ}_{0} {μ}_{r} Ir {\int }_{0}^{∞} {e}^{- kD} {J}_{1} ( kr ) {J}_{1} ( {k}_{i} ) k \times \frac{( K + {K}_{1} ) {e}^{{k}_{1} d} - ( K - {K}_{1} ) {e}^{- {k}_{1} d}}{( K + {K}_{1} ) {e}^{kd} - {( K - {K}_{1} )}^{2} {e}^{- kd}} dk \qquad [ Equation 2 ]$$

[Equation 2] can be substituted into [Equation 1], [Equation 3] below can be derived.

$$B ( r , z ) = ∇ \times B = [ {\sum }_{i = 1}^{n} A ( {r}_{i e} , {z}_{i e} ) ] \qquad [ Equation 3 ]$$

[Equation 3] is an equation representing a magnetic flux density according to a distance on an x-axis of the graphite 303 covering the working coil WC. That is, [Equation 3] can mean the magnetic flux density at an arbitrary point of the graphite covering the working coil.

[Equation 4] below can be obtained by integrating [Equation 3] representing the magnetic flux density at any one point of the graphite.

$${\sum }_{i = 1}^{n} B ( r , z ) = {\sum }_{i = 1}^{n} ∇ \times B \qquad [ Equation 4 ]$$

[Equation 4] is an equation representing a cumulative magnetic flux density from a central portion of the graphite 303 covering the working coil WC to a distance r on the x-axis.

Next, (b) of FIG. 4 is a graph illustrating the magnetic flux density according to the distance r on the x-axis of the graphite covering the working coil WC in [Equation 3] and a vertical distance d with the working coil WC, and (c) of FIG. 4 is a view illustrating the cumulative magnetic flux density from the central portion of the graphite covering the working coil WC to the distance r on the x-axis in [Equation 4] according to the vertical distance d with the working coil WC.

In (b) of FIG. 4, a first graph 401 is a graph showing a magnetic flux density according to the distance r on the x-axis of the graphite covering the working coil WC when the vertical distance d of the graphite to the working coil WC is a first distance, a second graph 403 is a graph showing a magnetic flux density according to the distance r on the x-axis of the graphite covering the working coil WC when the vertical distance d of the graphite to the working coil WC is a second distance greater than the first distance, and a third graph 405 is a graph showing a magnetic flux density according to the distance r on the x-axis of the graphite covering the working coil WC when the vertical distance d of the graphite to the working coil WC is a third distance greater than the second distance.

In (c) of FIG. 4, a fourth graph 407 is a graph showing a cumulative magnetic flux density according to the distance r on the x-axis of the graphite covering the working coil WC when the vertical distance d of the graphite to the working coil WC is a first distance, a fifth graph 409 is a graph showing a cumulative magnetic flux density according to the distance r on the x-axis of the graphite covering the working coil WC when the vertical distance d of the graphite to the working coil WC is a second distance greater than the first distance, and a sixth graph 411 is a graph showing a cumulative magnetic flux density according to the distance r on the x-axis of the graphite covering the working coil WC when the vertical distance d of the graphite to the working coil WC is a third distance greater than the second distance.

It is seen that the cumulative magnetic flux density of the graphite increases as the area covering the working coil WC increases, and the cumulative magnetic flux density of the graphite increases as the vertical distance d from the working coil WC decreases.

Therefore, as the vertical distance d from the working coil WC increases, a required cross-sectional area of the graphite to be inducted into the heating target increases.

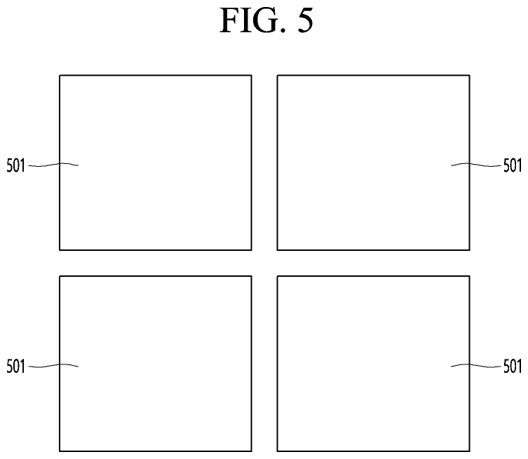

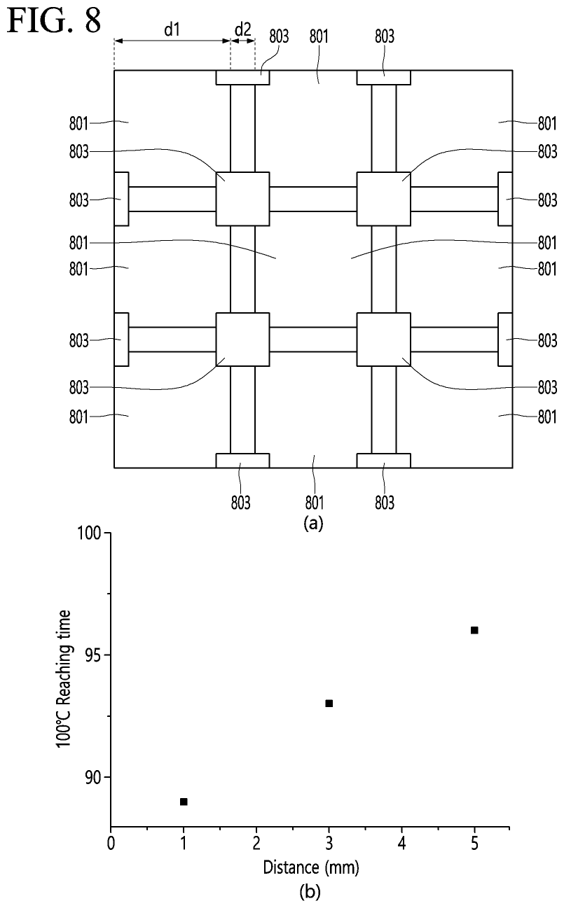

Then, referring to FIGS. 5 and 7, a graphite structure according to an embodiment of the present disclosure will be described.

FIG. 5 is a view of a graphite block according to an embodiment of the present disclosure.

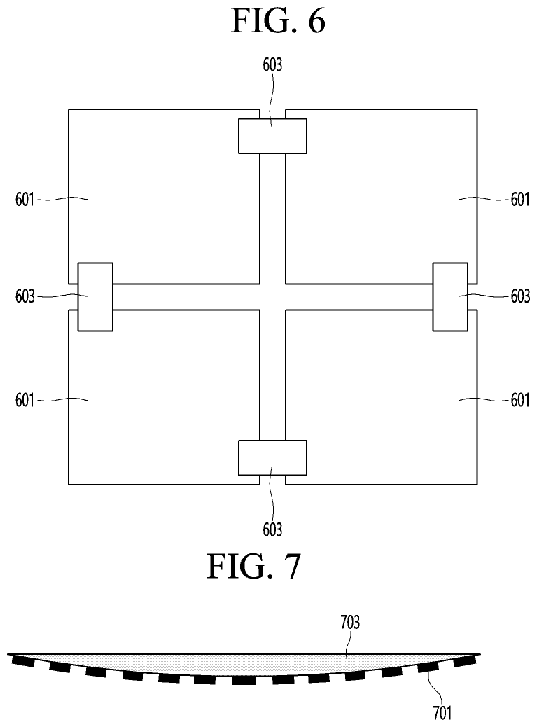

FIGS. 6 and 7 are views of a graphite structure according to an embodiment of the present disclosure.

A graphite structure according to an embodiment of the present disclosure can include a plurality of graphite blocks 501, 601, and 701 and at least one or more connection links 603 and 703 connecting the plurality of graphite blocks 501, 601, and 701 to each other.

Each of the connection links 603 and 703 according to an embodiment of the present disclosure can be a conductor. For example, each of the connection links 603 and 703 of the present disclosure can be a metal and can be aluminum, copper, graphite, or the like (e.g., any known conductor).

Referring to FIG. 5, when the plurality of graphite blocks 501 are separated from each other without the connection link(s), each graphite block 501 can have a magnetic flux density of a value a during induction heating. On the other hand, referring to FIG. 6, when the plurality of graphite blocks 601 are connected to each other through the connection link 603, the graphite structure can have a magnetic flux density of a value 4a, which is the sum of all magnetic flux densities the during the induction heating.

At least one or more connection links 603 and 703 according to an embodiment of the present disclosure can be arranged so that there is no graphite blocks 501, 601, and 701 that are not connected to each other among the plurality of graphite blocks 501, 601, and 701. That is, the connection links 603 and 703 can connect each of the graphite blocks 501, 601, 701 to one another. For example, the connection links 603 and 703 can be arranged to connect the adjacent graphite blocks 501, 601 and 701 to each other among the plurality of graphite blocks 501, 601 and 701.

That is, the graphite structure according to an embodiment of the present disclosure can include at least one or more connection links 603 and 703 that electrically connect the plurality of graphite blocks 501, 601, and 701 to each other.

In addition, all of the graphite blocks 501, 601, and 701 according to an embodiment of the present disclosure can have the same shape and size. According to an embodiment, each of the graphite blocks 501, 601, and 701 can have a rectangular parallelepiped shape or a flat plate shape. Alternatively, according to an embodiment, the graphite blocks 501, 601, and 701 can have different shapes and sizes. That is, within a group of blocks, such as blocks 501, each of the blocks 501 can have a different size and shape.

When each of the graphite blocks 501, 601, and 701 according to an embodiment of the present disclosure have a rectangular parallelepiped shape, the connection links 603 and 703 can be disposed to connect the graphite blocks 501, 601, and 701 of which surfaces are adjacent to each other among the plurality of graphite blocks 501, 601, and 701 to each other. Since each of the connection links 603 and 703 have a size less than that of each of the graphite blocks 501, 601 and 701, flexibility can be greater. That is, the connection links 603 and 703 allow for the group of graphite blocks to move. Thus, the graphite structure constituted by the plurality of small graphite blocks 501, 601, and 701 and the connection links 603 and 703 can have flexibility greater than that of a single large graphite block.

The plurality of graphite blocks 501, 601, and 701 according to an embodiment of the present disclosure can be disposed on a predetermined surface. The predetermined surface can mean a flat surface or can mean a curved surface. When placed on a curved surface, smaller graphite blocks and more connection links can be used to better conform to the curved surface, due to the added connection links providing flexibility to the assembly of graphite blocks.

When the graphite blocks 501, 601, and 701 of the present disclosure are arranged on a plane as illustrated in FIG. 5 or 6, the plurality of graphite blocks 501, 601, and 701 can be arranged in an N×M array, where N and M are nonzero integers. For example, when the graphite blocks are arranged in a 2×2 array, the graphite structure of the present disclosure can be constituted by 4 graphite blocks.

In addition, the graphite blocks 501, 601, and 701 according to an embodiment of the present disclosure can be disposed on the curved surface as illustrated in FIG. 7, and each of the connection links 603 and 703 itself connecting the graphite blocks 501, 601 and 701 to each other can be provided as a curved surface.

Here, the connection link 703 can be made of stainless, but this is only an example.

According to the present disclosure, there can be an advantage in that the graphite blocks 501, 601, and 701 are used as a main object to be heated or an auxiliary object to be heated for the induction heating.

In addition, according to the present disclosure, the magnetic flux similar to that of the large graphite block can be induced by the small graphite blocks 501, 601, and 701, which is advantageous to the process.

In addition, according to the present disclosure, there can be an advantage in that the flexible object to be heated is capable of being manufactured by disposing the small graphite blocks 501, 601, and 701 on the curved surface.

FIG. 8 is a view for explaining heating characteristics depending on a distance between the graphite blocks according to an embodiment of the present disclosure. Referring to (a) of FIG. 8, the graphite structure includes a plurality of graphite blocks 801 and a connection link 803 connecting the plurality of graphite blocks 801 to each other.

According to an embodiment of the present disclosure, a size of one side dl of each of the graphite block 801 can be 5 cm, and a distance d2 between the graphite blocks can be one of 1 mm, 3 mm, and 5 mm.

Referring to (b) of FIG. 8, when the distance d2 between the graphite blocks 801 is 1 mm, it takes about 89 seconds to reach a temperature of 100° C., when the distance d2 is 3 mm, it takes about 93 seconds to reach a temperature of 100° C., and when the distance d2 is 5 mm, it takes about 96 seconds to reach a temperature of 100° C.

That is, it is seen that heating efficiency of the graphite structure according to an embodiment of the present disclosure is deteriorated as the distance between the graphite blocks 801 increases.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1-12. (Canceled)

13. A graphite structure, comprising:
a plurality graphite blocks; and
one or more connection links connecting the plurality of graphite blocks to each other.

14. The graphite structure according to claim 13, wherein each of the one or more connection links is a conductor.

15. The graphite structure according to claim 14, wherein each of the one or more connection links comprises graphite.

16. The graphite structure according to claim 13, wherein the one or more connection links are disposed so that the graphite blocks that are not connected to each other among the plurality of graphite blocks are not provided.

17. The graphite structure according to claim 13, wherein the one or more connection links connect adjacent graphite blocks among the plurality of graphite blocks to each other.

18. The graphite structure according to claim 13, wherein each of the plurality of graphite blocks has a same shape and size.

19. The graphite structure according to claim 18, wherein each of the plurality of graphite blocks has a rectangular parallelepiped shape.

20. The graphite structure according to claim 19, wherein the one or more connection links are disposed to connect graphite blocks having surfaces that are adjacent to each other among the plurality of graphite blocks.

21. The graphite structure according to claim 13, wherein the plurality of graphite blocks are disposed on a same plane.

22. The graphite structure according to claim 21, wherein the plurality of graphite blocks are disposed in an N×M matrix, where N and M are nonzero integers.

23. The graphite structure according to claim 13, wherein the plurality of graphite blocks are disposed on a curved surface.

24. An arrangement method of a graphite structure, the arrangement method comprising:
disposing a plurality of graphite blocks on a predetermined surface; and
disposing at least one or more connection links connecting the plurality of graphite blocks.

25. The arrangement method according to claim 24, wherein the one or more connection links connect the plurality of graphite blocks to one another.

26. The arrangement method according to claim 24, wherein the predetermined surface is a curved surface.

27. The arrangement method according to claim 24, wherein each of the one or more connection links is comprised of graphite.

28. The arrangement method according to claim 24, wherein the one or more connection links are symmetrically disposed.

29. The arrangement method according to claim 24, wherein the predetermined surface is an upper plate of an induction heater.

30. The arrangement method according to claim 29, wherein a size of the graphite structure is determined based on a diameter of a working coil of the induction heater.

31. A graphite structure, comprising:
a plurality graphite blocks disposed along a same plane; and
a plurality of connection links electrically connecting the plurality of graphite blocks,
wherein a size of the graphite structure corresponds to a diameter of a working coil of an induction heater.
